(19) United States
(12) Patent Application Publication
(10) Pub. No.: US 2006/0048135 A1
(43) Pub. Date: Mar. 2, 2006

(54) Method of monitoring and controlling applications in an ACD

(76) Inventors: Jeff Hodson, Wheaton, IL (US); Mike Hollatz, Huntley, IL (US)

Correspondence Address: Welsh & Katz, Ltd.;Jon P. Christensen, 22nd Floor, 120 South Riverside Plaza, Chicago, IL, 60606, US

(21) Appl. No.: 10/930,997

(22) Filed: Aug. 31, 2004

(51) Int. Cl. G06F 9/44

(52) U.S. Cl. 717/172; 717/121; 717/164

(57) ABSTRACT

A method and apparatus are provided for monitoring and controlling a plurality of computing applications in an automatic contact distribution system. The method includes the steps of objectively determining an availability of resources of the automatic contact distributor and automatically activating an application of the plurality of computing applications when the objectively determined resource availability within the automatic call distributing system exceeds a resource requirement of the application.

### FIELD OF THE INVENTION

The field of the invention relates to computer systems and more particularly, to automatic call distributors.

### BACKGROUND OF THE INVENTION

Automatic call distributors (ACDs) are known. Such systems are typically used by organizations to serve large numbers of callers through the Public Switched Telephone Network (PSTN). Typically, inbound calls are directed to a common telephone number of the organization and distributed to agents based upon some criteria (e.g., agent idle time).

In addition to handling inbound calls, ACDs may also process outbound calls. Typically, a controller monitors a workload of its agents. Where a workload of received calls falls below some threshold value, the controller may begin to initiate outbound calls.

In addition to placing and distributing calls, an ACD may also identify and display documents on agent terminals as an aid to processing the calls. In the case of incoming calls, the calls may be received along with dialed number identification service (DNIS) and/or automatic number identification (ANI) information. ANI may be used to identify a caller at the same instant as the call is delivered to the ACD. The controller of the ACD may use the ANI information to retrieve and display customer records on a terminal of the agent selected to handle the call at the same instant that the call is delivered to the agent.

In addition, textual information may be displayed on a terminal of the agent that guides the agent through a sales presentation. DNIS information may be used to identify an intended call target and to select an appropriate sales presentation for use by the agent based upon the intended call target.

While automatic call distributors work relatively well, they are not particularly well suited to handling Internet calls. Further, the standards that are used for processing switched circuit calls through the PSTN cannot be used with packet-switched calls processed through the Internet. In addition, calls routed through the Internet often rely upon routers and other support systems whose failure is difficult to detect. Because of the additional complexity of the Internet, a need exits for a method of detecting and accommodating the unavailability and/or loading of support systems that process calls through the Internet.

### SUMMARY

A method and apparatus are provided for monitoring and controlling a plurality of computing applications in an automatic contact distribution system. The method includes the steps of objectively determining an availability of resources of the automatic contact distributor and automatically activating an application of the plurality of computing applications when the objectively determined resource availability within the automatic call distributing system exceeds a resource requirement of the application.

### BRIEF DESCRIPTION OF THE DRAWINGS

FIG. 1 is a block diagram of a contact distribution system in accordance with an illustrated embodiment of the invention.

### DETAILED DESCRIPTION OF AN ILLUSTRATED EMBODIMENT

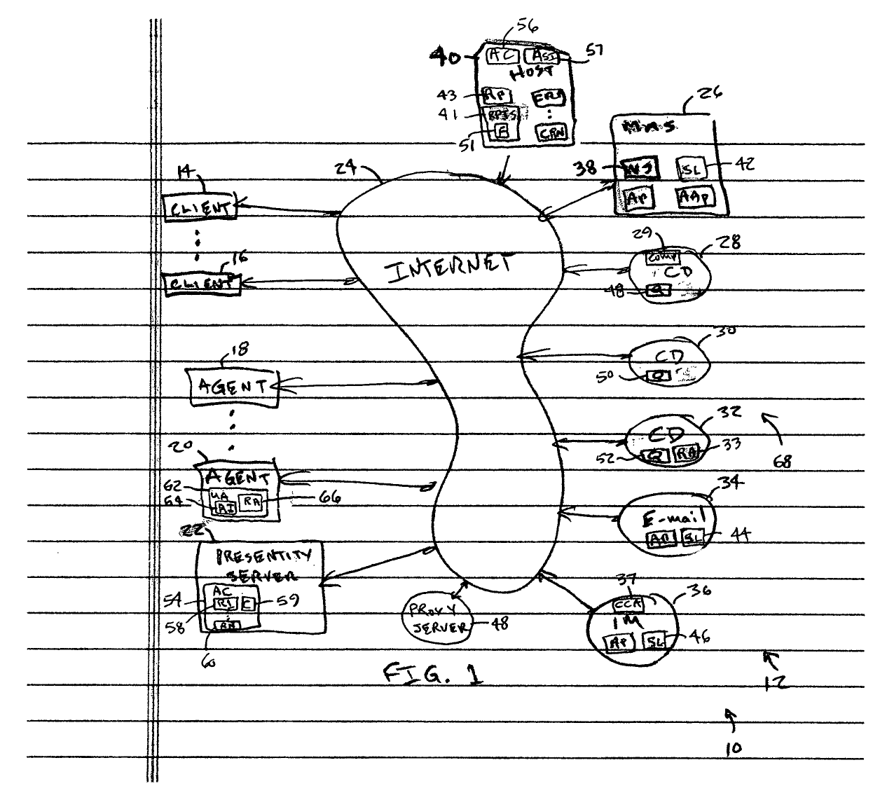

FIG. 1 is a block diagram of a contact distribution system 10 shown under an illustrated embodiment of the invention. The contact distribution system may be used for connecting calls through the Internet 24 between clients 14, 16 and agents 18, 20. In general, the system 10 may be used by any of a number of different enterprise organizations (e.g., commercial, environmental, political, etc.) to advance the agenda of the enterprise.

The system 10 may include a number of computer resources (e.g., applications 26, 28, 30, 32, 34, 36) that function to form the connections between clients 14, 16 and agents 18, 20. Also shown in FIG. 1 is a computer application tracking and control system 12 that may be used to monitor the availability of the computer resources of the system 10 and to control the activation and deactivation of applications and/or subsystems.

As used herein, a computer resource of the organization is a processing capability of a computer application that is directed related to enterprise operations of the organization. Using the Open Systems Interconnection (OSI) network model, computer resources are related to user applications that operate from Layer 7 of the OSI model.

The tracking and control system 12 may be used to activate and de-activate computer applications based upon the loading level of other computer applications or subsystems. As used herein, the term “loading level” means the number of repetitions of particular task that an application is currently performing during a particular time period versus the maximum number of repetitions of the particular task that the application is capable of performing during that same time period. Alternatively, the term “loading level” means the processing time tᵢ of a particular task on a processor that is otherwise not loaded compared with a processing time ta of the task on that same processor under a current processing conditions using the equation 1−tᵢ/tₐ.

Under one illustrated embodiment, the tracking and control system 12 objectively determines the resources available within the system 10 and activates or deactivates applications based upon the availability of those resources. As used herein, the objective determination of resource availability involves a comparison of resources with a predetermined enterprise threshold value for the resource and a determination that the response exceeds the predetermined threshold value. In the case of resources within a single agent terminal, an objective standard for determining resource availability may be determined on an ad hoc basis by a priori testing. In the context of intra-processor communication within the automatic contact distribution system resource availability may be determined by real-time testing (e.g., pinging).

The controlled applications may be any application whose operation is directly related to the business objectives of the enterprise. For example, the contact distribution system 10 of FIG. 1 may have one or more contact distributors 28, 30, 32 that distribute contacts to agents 18, 20. During periods of light use only one contact distributor 30, 32 may be needed and the others may be either shut down or put to some other use.

Alternatively, the controlled application may be an agent interface within an agent terminal 18, 20. If the tracking system 12 should determine that the agent has too many windows open on his terminal, then the tracking system 12 may not allow the agent to receive calls.

In another alternative, automatic contact distributors usually have a number of reporting applications that collect data from other supporting applications and report on the operation of the automatic contact distributor. However, operation of the reporting application during periods of heavy system loading reduces the automatic contact distributor's ability to perform its primary operation. The tracking and control system 12 may function to determine the loading of the other, supporting applications that provide information to the reporting application and activate or deactivate the reporting application when the supporting applications are above a threshold loading level.

As described below, at least some of the computer resources are used to perform predetermined services for other computer resources in furtherance of enterprise objectives. As used herein, a predetermined service performed by one resource for another means the processing of data to achieve some enterprise result that is not directly related to communication connections through the Internet.

Access to the contact center 10 of the organization by clients 14, 16 of the organization may be provided through the Internet 14 under any of a number of different processes. In order to promulgate the agenda of the organization to its clients 14, 16, the organization may publish contact information (e.g., e-mail address, instant message (IM) address or universal resource locator (URL)), by advertising or otherwise, that identifies a communication path to the organization.

Under the illustrated embodiment, the contact distribution system 10 may include one or more servers 26, 34, 36 that may function to receive and initially process calls. A first server 34 may receive calls in the form of e-mails. A second server 36 may receive calls under an Instant Messaging (IM) format. A third multi-mode server 26 may receive calls from one or more webpages downloaded to clients 14, 16 from a website 38 of the multi-mode server 26.

In the case where the organization is a manufacturer with many different products, a different e-mail address may be provided for each different product line. As such, the e-mail server 34 may receive e-mails directed to many different addresses that are all within one or more domain names used by the e-mail server 34. The use of different destination addresses may be used to provide the system 10 with a first level indication of the call type, of the received call. The IM server 36 and multi-mode server 26 may be used in a similar manner.

Calls processed by the servers 26, 34, 36 may be initiated in any of a number of different ways. For example, a call from a client 14, 16 to the multi-mode server 26 may be initiated by activation of a SPEAK WITH AGENT softkey on a webpage downloaded from the multi-mode server 26. Alternatively, calls from clients 14, 16 may by initiated in response to pop-up ads posted to websites visited by clients 14, 16. Calls may also be initiated conventionally by a client 14, 16 activating an appropriate application (e.g., Outlook by Microsoft) and entering a Universal Resource Locator (URL) of the organization under an e-mail or IM format in response to a printed ad in a newspaper or magazine.

Calls from clients 14, 16, received by the servers 26, 34, 36 may be distributed to agents 18, 20 through a number of call distributors 28, 30, 32. As the calls arrive, the server 26, 34, 36 receiving the call may open a file for each call identified by a unique call identifier. The file may include at least a source identifier (e.g., an e-mail address, URL, etc.) of the client 14, 16 originating the call and a destination identifier that identifies the call destination (e.g., e-mail address, URL, etc.) within the system 10. In the case of calls received by the multi-mode server 26, information regarding any webpages visited may also be included within the call file.

A copy of each call file may be transferred to the host 40. Within the host 40, the information within the call file may be used to identify further information about the caller. For example, the source identifier may be used to classify the call as originating from existing or new customers. Information on webpages visited or on prior contacts with the client 14, 16 may be used to provide information regarding the type of call involved.

Any additional information regarding the call may be transferred back to the server 26, 34, 36. Within the server 26, 34, 36, the information within the call file and, possibly, any additional information from the host 26 may be used within a call classification application 37 to further classify the call into one or more call types.

Once a call type has been determined, the server 26, 34, 36 may transfer the call to a call distributor 28, 30, 32. The call distributor 28, 30, 32 that the server 26, 34, 36 selects to handle the call may be based upon availability or upon the call type.

Before the server 26, 34, 36 transfers the call to a call distributor 28, 30, 32, the server 26, 34, 36 may first determine which call distributors 28, 30, 32 are available to receive calls. The server 26, 34, 36 may determine availability from a status list 42, 44, 46 that contains information on status provided by a presence server 22.

Selection of a contact distributor 28, 30, 32 may be based simply upon status or upon some predetermined criteria. For example, the first call distributor 28 may be associated with agents 18, 20 who are primarily skilled at handling calls of a first call type and who have secondary skills in handling calls of a second type and third call type. Similarly, the second call distributor 30 may be associated with agents 18, 20 who are primarily skilled at handling calls of a second call type and who have secondary skills in handling calls of a first type and third call type and the third call distributor 32 may be associated with agents 18, 20 who are primarily skilled at handling calls of a third call type and have secondary skills in handling calls of a first type and second call type.

As such, calls of the first call type will normally be transferred to the first call distributor 28, calls of the second call type will be transferred to the second call distributor 30 and calls of the third call type will be transferred to the third call distributor 32. However, if one or more of the call distributors 28, 30, 32 is inoperative or otherwise unavailable or is overloaded, then calls may be handled by any other call distributor 28, 30, 32.

If the primary call distributor 28, 30, 32 is available, then the server 26, 34, 36 may transfer the call along with the file to the appropriate server 28, 30, 32. Within the call distributor 28, 30, 32, a call routing application 33 may compare the contents of the call file with a list of agent skills and may assign the call to a qualified agent 18, 20. If an agent is not available, then the agent selection processor may place the call in a call queue 48, 50, 52 pending availability of a qualified agent.

Turning now to the apparatus 12 for monitoring and controlling applications, an explanation will be provided as to how the apparatus 12 functions to control applications based upon the status of the system 10. In this regard, a set of computer applications may interact with the tracking apparatus 12 based upon a predetermined set of Session Initiation Protocol (SIP) exchanges defined by the Internet Engineering Task Force (IETF) RFC #3261.

For example, the tracking apparatus 12 may include a presence server 22 that has the same functionality as presence servers defined in RFC #3261. For example, whenever a contact distributor 28, 30, 32 is activated, it searches for and registers its presence and status by sending a SIP REGISTER message to the presence server 22 using processes defined by RFC #3261. The REGISTER message may include an expiration time period and may be periodically updated by the contact distributor 28, 30, 32.

Similarly, the servers 26, 34, 36 may send a SIP SUBSCRIBE message under RFC #3261 to the presence server 22 identifying the contact servers 28, 30, 32 and requesting status information regarding the contact distributors 28, 30, 32. In turn, the presence server 22 may confirm that the contact server 28, 30, 32 is registered and forward the SUBSCRIBE message to the respective contact servers 28, 30, 32 requesting a SIP NOTIFY message from the contact distributors 28, 30, 32 under RFC #3261.

In response, the contact distributors 28, 30, 32 may forward NOTIFY messages to the presence server 22 and, ultimately, to the servers 26, 34, 36 to notify the servers 26, 34, 36 (i.e., the watcher) of any of a number of status conditions (e.g., online, offline, etc.) and status change events. For example, status change events may simply provide notification regarding the availability or unavailability of the contact distributor 28, 30, 32 or the status information may provide information regarding loading levels of the contact distributors 28, 30, 32.

With regard to loading levels, a length of a call queue 48, 50, 52 may be compared within a comparator 29 with a predetermined threshold level for each call distributor 28, 30, 32. When the queue length exceeds the threshold value, the contact distributor 28, 30, 32 may forward a NOTIFY message notifying the server 26, 34, 36 that it is unavailable for any more calls. When the queue length does not exceed the threshold value, the contact distributor 28, 30, 32 may forward a NOTIFY message notifying the server 26, 34, 36 that it is available for more calls. Alternatively, the NOTIFY message may contain an actual loading level of the call distributors 28, 30, 32 attached as a suffix.

The servers 26, 34, 36 may also send SIP REGISTER messages to the presence server 22 to register their presence within the system 10. A reports generator 41 within the host 40 may send a SIP SUBSCRIBE message to the presence server 22 requesting the status of the servers 26, 34, 36 and contact distributors 28, 30, 32. By receiving status information, the report generator 41 is made aware of which servers 26, 34, 36 and contact distributor 28, 30, 32 are available and that have data for generating reports. Further, notification that a server 26, 34, 36 or contact distributor 28, 30, 32 is offline may itself justify the need for additional reporting data. The use of the SUBSCRIBE and NOTIFY functions of the apparatus 12 for tracking system availability allow the report generator to generate more accurate reports even in the absence of data from any particular server 26, 34, 36 or contact distributor 28, 30, 32.

In a similar manner, a registration agent 66 within each agent terminal 18, 20 may send a SIP REGISTER message to the presence server 48 registering its presence and loading level. In this case, the loading level may be an actual CPU loading retrieved from the CPU of the terminal of the terminal 18, 20 or may be based upon the number of windows opened on the terminal. The loading level may be appended to the SIP registration message as a suffix to a source address.

A reconfiguration processor 43 may subscribe to the status of the servers 26, 34, 36. In the event that the reconfiguration processor 43 should detect that a server 26, 34, 36 goes offline, the reconfiguration processor 43 may instruct a proxy server 48 to direct any calls that would have gone to the offline server 26, 34, 36 to, instead, go to one of the remaining servers 26, 34, 36.

In addition to the reconfiguration processor 43 that attempts to reconfigure the system 10 to accommodate a shutdown, one or more applications controllers 54, 56 within the tracking system 12 may control the activation or deactivation of computer applications based upon the status of the system 10. In the event of the failure of one or more of the applications within the system 10, it is the responsibility of the application controllers to re-start (re-initialize) the failed application.

In this regard, the application controllers 54, 56 may be provided with a list of controlled applications or subsystems. (In this case, a subsystem refers to a group of applications dedicated to some common enterprise function.) To determine the status of each application or subsystem, the applications controllers 54, 56 may subscribe to the status of each application that registers within the PRESENCE server 22.

The application controllers 54, 56 may be provided with a list of resources 58, 60 for each of the controlled applications and subsystems. The resources of each application may be retrieved from the application or separately provided to the controller 54, 56 during application set up. The list of resources 58, 60 may define a set of requirements for the activation or deactivation of one or more computer applications. In this regard, the list of resources may include or define a set of requirements that allow the application or system to function according to its intended purpose.

The list of resources for each application may include a set of positive and negative requirements. For example, one resource required by a server 26, 34, 36 is the availability of one or more contact distributors 28, 30, 32. The list of resources 58, 60 for an agent sign-in application 57 may include the negative requirement that the application 57 approve a certain percentage of sign-in requests or a determination is made that the sign-in application needs to be re-initialized. Alternatively, the list of resources for an agent terminal 18, 20 may include the requirement that the CPU be operating below a certain loading level before an agent interface application 64 is allowed to start and remains below a certain loading level in order that each new call is delivered to the agent terminal 18, 20.

In the case of the contact distributors 28, 30, 32, a first resource list 58, 60 may be provided for a contact distributor subsystem 68 and a second resource list 58, 60 for each of the individual contact distributors 28, 30, 32. The first resource list 58, 60 may include a minimum cumulative loading level for all of the contact distributors 28, 30, 32. If the loading of the subsystem 68 falls below that minimum level, then one or more of the call distributors 28, 30, 32 may be deactivated and the load transferred to the remaining call distributors 28, 30, 32.

With regard to the second resource list, if the loading of any contact distributor is less than some predetermined threshold value (e.g., 10%) and the other contact distributors is less than some other predetermined threshold value (e.g., 80%), then the lightest loaded contact distributor may be deactivated and the other contact distributors may assume the loading of the deactivated contact distributor. The second resource list 58, 60 may also require that the contact distributor 28, 30, 32 periodically register is presence or respond to pings. If the contact distributor does neither, then the contact distributor 28, 30, 32 may be reinitialized by the application controller 54, 56.

During operation of the automatic contact distributor, the application controller 54, 56 may be constantly monitoring and objectively determining the resources available within the system 10. Monitoring may include retrieving registration information from the presence server 22 and objectively comparing the retrieved information with each resource list within a comparator 59. When the application controller 54, 56 detects a match between a set of resources associated with a particular controlled application or subsystem, the application controller 54, 56 may set a flag 51 within an associated application. Setting the flag 51 within an application has the effect of reinitializing, activating or deactivating the application based upon the context.

In another embodiment, the application controller 54, 56 may ping certain resources of the system 10 to form an objective determination of system response. For example, an application controller 54 may ping the host 40 to measure an overall response time at the host 40 and Internet 24. By knowing a loading level of the host 40, the response time of the host 40 may be subtracted from the overall response time to determine a response time of the Internet 24 between the node of the presence server 22 and the host 40. If the resource file 58, 60 includes a maximum response time for the host 40 and the measured response time exceeds a threshold value of the resource file 58, 60, then the application controller 54 may deactivate predetermined applications 41, 43.

A specific embodiment of method and apparatus for tracking the availability of resources of a computer system has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of monitoring and controlling a plurality of computing applications in an automatic contact distribution system, such method comprising the steps of:
objectively determining an availability of resources of the automatic contact distributor; and
automatically activating an application of the plurality of computing applications when the objectively determined resource availability within the automatic call distributing system exceeds a resource requirement of the application.

2. The method of monitoring and controlling as in claim 1 further comprising determining a resource requirement of the application.

3. The method of monitoring and controlling as in claim 1 wherein the step of determining a resource requirement of the application further comprises identifying another computer application of the plurality of computer applications that interacts with the application.

4. The method of monitoring and controlling as in claim 1 wherein the step of determining a resource requirement of the application further comprises determining a maximum loading level of the other application that allows the application to achieve a predetermined performance level.

5. The method of monitoring and controlling as in claim 4 further comprising providing a SIP presence server for tracking the availability of resources.

6. The method of monitoring and controlling as in claim 5 further comprising at least some of the plurality of applications registering a loading level of the respective plurality of applications with the presence server.

7. The method of monitoring and controlling as in claim 6 wherein the step of determining the availability of resources further comprises retrieving the registered loading level of the at least some applications.

8. The method of monitoring and controlling as in claim 7 wherein the step of retrieving the registered loading level of the at least some applications further comprises sending a SIP REGISTER message to the SIP presence server.

9. The method of monitoring and controlling as in claim 7 further comprising comparing the retrieved loading level with the maximum loading level of the other application and activating the application when the retrieved loading level does not exceed the maximum loading level.

10. The method of monitoring and controlling as in claim 9 further comprising comparing the retrieved loading level with the maximum level of the other application and de-activating the application when the retrieved loading level exceeds the maximum loading level.

11. The method of monitoring and controlling as in claim 1 further comprising retrieving a resource requirement from the application.

12. The method of monitoring and controlling as in claim 11 further comprising pinging a computer resource of the retrieved resource requirements of the application.

13. The method of monitoring and controlling as in claim 12 further comprising measuring a delay between transmission of the ping and detecting receipt of a response to the ping.

14. The method of monitoring and controlling as in claim 13 further comprising comparing the measured delay with a threshold value for the computer resource.

15. An apparatus for monitoring and controlling a plurality of computing applications in an automatic contact distribution system, such apparatus comprising:
means for objectively determining an availability of resources of the automatic contact distributor; and
means for automatically activating an application of the plurality of computing applications when the objectively determined resource availability within the automatic call distributing system exceeds a resource requirement of the application.

16. The apparatus for monitoring and controlling as in claim 15 further comprising means for determining a resource requirement of the application.

17. The apparatus for monitoring and controlling as in claim 15 wherein the means for determining a resource requirement of the application further comprises means for identifying another computer application of the plurality of computer applications that interacts with the application.

18. The apparatus for monitoring and controlling as in claim 15 wherein the means for determining a resource requirement of the application further comprises means for determining a maximum loading level of the other application that allows the application to achieve a predetermined performance level.

19. The apparatus for monitoring and controlling as in claim 18 further comprising means for providing a SIP presence server for tracking the availability of resources.

20. The apparatus for monitoring and controlling as in claim 19 further comprising means within at least some of the plurality of applications for registering a loading level of the respective plurality of applications with the presence server.

21. The apparatus for monitoring and controlling as in claim 20 wherein the means for determining the availability of resources further comprises means for retrieving the registered loading level of the at least some applications.

22. The apparatus for monitoring and controlling as in claim 21 wherein the means for retrieving the registered loading level of the at least some applications further comprises means for sending a SIP REGISTER message to the SIP presence server.

23. The apparatus for monitoring and controlling as in claim 21 further comprising means for comparing the retrieved loading level with the maximum loading level of the other application and activating the application when the retrieved loading level does not exceed the maximum loading level.

24. The apparatus for monitoring and controlling as in claim 23 further comprising means for comparing the retrieved loading level with the maximum level of the other application and de-activating the application when the retrieved loading level exceeds the maximum loading level.

25. The apparatus for monitoring and controlling as in claim 15 further comprising means for retrieving a resource requirement from the application.

26. The apparatus for monitoring and controlling as in claim 25 further comprising means for pinging a computer resource of the retrieved resource requirements of the application.

27. The apparatus for monitoring and controlling as in claim 26 further comprising means for measuring a delay between transmission of the ping and detecting receipt of a response to the ping.

28. The apparatus for monitoring and controlling as in claim 27 further comprising means for comparing the measured delay with a threshold value for the computer resource.

29. An apparatus for monitoring and controlling a plurality of computing applications in an automatic contact distribution system, such apparatus comprising:
a SIP presence server that objectively determines an availability of resources of the automatic contact distributor; and
an application controller that automatically activates an application of the plurality of computing applications when the objectively determined resource availability within the automatic call distributing system exceeds a resource requirement of the application.

30. The apparatus for monitoring and controlling as in claim 29 further comprising a resource file that provides a resource requirement of the application.

31. The apparatus for monitoring and controlling as in claim 30 wherein the resource file further comprises a threshold value that determines a maximum loading level of the other application that allows the application to achieve a predetermined performance level.

32. The apparatus for monitoring and controlling as in claim 31 further comprising a user agent within at least some of the plurality of applications for registering a loading level of the respective plurality of applications with the presence server.

33. The apparatus for monitoring and controlling as in claim 32 wherein the SIP presence server further comprises a SIP REGISTER message that transfers resource information between the SIP presence server and an application of the plurality of computer applications.

34. The apparatus for monitoring and controlling as in claim 33 further comprising a comparator that compares the retrieved loading level with the maximum loading level of the other application and activates the application when the retrieved loading level does not exceed the maximum loading level.

35. The apparatus for monitoring and controlling as in claim 34 wherein the comparator de-activates the application when the retrieved loading level exceeds the maximum loading level.

36. A method of monitoring and controlling a plurality of computing applications in an automatic contact distribution system, such method comprising the steps of:
objectively determining an availability of resources that are used by an application of the automatic contact distributor computing applications; and
activating the application when the objectively determined resource availability within the automatic call distributing system exceeds a resource requirement of the application.

37. A method of monitoring and controlling a plurality of computing resources in an automatic contact distribution system, such method comprising the steps of:
determining a resource requirement of an application of the plurality of applications;
determining a resource availability of the determined resource requirement within the automatic contact distribution system;
comparing the resource requirement with the resource availability; and
activating the application when the resource availability exceeds the resource requirement of the application.

38. The method monitoring and controlling computing resources as in claim 37 further comprising deactivating the application when the resource availability does not exceed the resource requirement.

39. The method monitoring and controlling computing resources as in claim 37 further comprising the application registering a loading level with a presence server.
